(19) United States
(12) Patent Application Publication
(10) Pub. No.: US 2011/0232288 A1
(43) Pub. Date: Sep. 29, 2011

(54) METHOD OF REDUCING COMBUSTION INSTABILITIES BY CHOOSING THE POSITION OF A BLEED AIR INTAKE ON A TURBOMACHINE

(75) Inventors: Marie Bizouard, Bretigny sur Orge (FR); Emilie Lachaud, Villejuif (FR); Sebastien ROUX, Reau (FR)

(73) Assignee: SNECMA, Paris (FR)

(21) Appl. No.: 13/053,779

(22) Filed: Mar. 22, 2011

(30) Foreign Application Priority Data
Mar. 23, 2010 (FR) 10 52105

(51) Int. Cl. F23M 5/00; G10K 11/16

(52) U.S. Cl. 60/722; 181/296

(57) ABSTRACT

Method of reducing acoustic vibratory phenomena in the environment of a combustion chamber of a turbomachine, said chamber being positioned in a cavity delimited by an exterior casing and an interior chamber casing, characterized in that it includes at least the following steps:
producing an analysis of at least one vibratory mode of the chamber and the cavity and identifying its resonant frequency and the associated pressure nodes and antinodes,
choosing for the vibratory mode to be processed a pressure antinode existing at the level of one of the walls,
installing at the level of said antinode a bleed air intake pipe,
resuming the analysis of the vibratory mode and identifying the new resonant frequency,
determining the length and diameter parameters for said pipe by iteration until the required frequency shift for the vibratory mode concerned is obtained.

The field of the present invention is that of turbomachines and more particularly that of the acoustic in the environment of turbomachine combustion chambers.

A turbomachine conventionally comprises, in the upstream to downstream direction of the flow of gases, a fan, one or more compressor stages, for example a low-pressure compressor and a high-pressure compressor, a combustion chamber, one or more turbine stages, for example a high-pressure turbine and a low-pressure turbine, and a gas exhaust nozzle.

The combustion chamber is fed with air from the compressor or compressors, which fills a cavity surrounding the chamber before entering said chamber to participate in the combustion of fuel injected into it.

The shape of this cavity is relatively complex because it is the result of choices made as to the positioning of the various components of the engine. As in any cavity in which a fluid flows, acoustic phenomena may arise therein, which may compromise the service life of the walls of this cavity and the chamber itself. It is therefore imperative to control closely pressure fluctuations that may arise therein and above all to prevent the occurrence of acoustic resonances.

Because of the presence in the combustion chamber of a flame that is not perfectly stable over time, combustion fluctuations generate pressure fluctuations in the chamber and in the cavity that surrounds it. It is necessary to prevent coupling phenomena occurring between the combustion instabilities and the acoustic modes of the chamber which would give rise to the occurrence of resonances accompanied by potentially destructive vibratory phenomena in the walls that are subjected to these acoustic vibrations.

The engine designer must therefore pay attention to acoustic modes in the chamber and the cavity that surrounds it and must be able to modify the frequencies of these modes as a function of the known vibratory frequencies of the combustion fluctuations. Complex calculation codes have been developed to determine the natural modes o f the acoustic vibrations in the cavities concerned. They are based on solving the Helmholtz equation as a function of the geometry of the combustion chamber taking into account its environment, i.e. the presence of the injection system, the air inlet diffuser and the HP turbine nozzle. They also take into account the limiting acoustic conditions at the walls.

Once the acoustic vibratory modes of the cavities are known, it remains to eliminate the hazardous modes, i.e. those liable to cause resonance in response to excitation by combustion in the chamber. At present there is no systematic solution to this problem and it is still not known how to eliminate these modes with certainty. Modification of the geometry of the combustion chamber is often envisaged but is complicated to put into practice and difficult to use to solve a problem that occurs after commissioning the turbomachine. It is sometimes possible to operate on combustion in an attempt to prevent the occurrence of resonances between the flame and the acoustic, for example by modifying the injection system. However, once again, modifying the injection system can have complex repercussions that cannot always be controlled.

Another practice encountered for passive control or elimination of acoustic modes is introducing acoustic barriers into a region in which the flow has a low level of activity, for example in the low part of chambers featuring a bypass, but acoustic barriers generate head loss in the bypass.

None of these methods is simple to put into practice and it is not always possible to obtain the required result using them.

Also known in the art is the provision of Helmholtz resonators connected to the combustion chamber that modify the vibratory modes. However these devices, such as those described in the patent applications GB 2443838 and EP 1517087, have the drawback of adding devices and thus increasing the mass of the engine.

One aim of the present invention is to eliminate these drawbacks by proposing a method for shifting the acoustic modes of the combustion chamber and the cavity that surrounds it, that does not have at least some of the drawbacks of the prior art, is simple to put into practice and can be applied even to chambers with a highly complex geometry.

To this end, the invention provides a method of reducing acoustic vibratory phenomena in the environment of a combustion chamber of a turbomachine, said chamber being positioned in a cavity delimited by an exterior casing and an interior chamber casing, characterized in that it includes at least the following steps:
producing an analysis of at least one vibratory mode of the chamber and the cavity and identifying its resonant frequency and the pressure nodes and antinodes associated with that frequency,
choosing for the vibratory mode to be processed a pressure antinode existing at the level of one of the walls delimiting the cavity,
installing at the level of said antinode a bleed air intake pipe characterized by its diameter and its length,
resuming the analysis of the vibratory mode after introducing said pipe and identifying the new resonant frequency,
determining the length and diameter parameters of said pipe by iteration until the required frequency shift for the vibratory mode concerned is obtained.

Simply by positioning a bleed air intake pipe at an optimum location on the exterior wall of the chamber the acoustic frequency of the combustion chamber and the cavity that surrounds it is shifted and thus resonance phenomena avoided.

To simplify the acoustic calculation the pipe is preferably treated like a Helmholtz resonator during the vibratory analysis.

The invention also claims a turbomachine module comprising a combustion chamber and a cavity that surrounds it, one wall of which carries a bleed air intake pipe for pressurizing or supplying with air elements of the aircraft or the engine, positioned with the assistance of the method described above. It finally claims a turbomachine including a module of this kind.

The invention will be better understood and other aims, details, features and characteristics thereof will become more clearly apparent in the course of the following detailed explanatory description of one embodiment of the invention given by way of purely illustrative and nonlimiting example with reference to the appended diagrammatic drawings.

In the drawings:

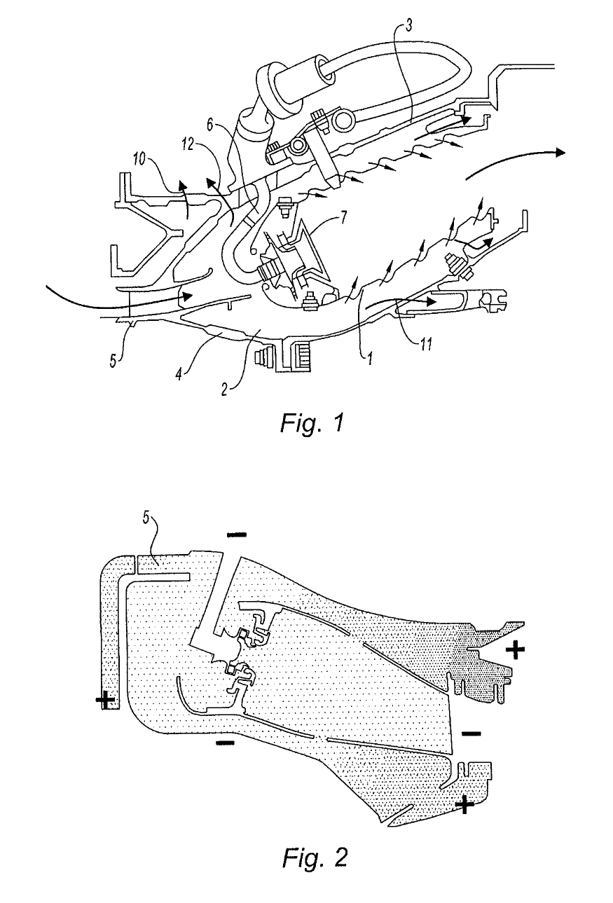

FIG. 1 is a view in section of a turbomachine combustion chamber;

FIG. 2 shows the distribution of the amplitude of the pressure fluctuations in a combustion chamber;

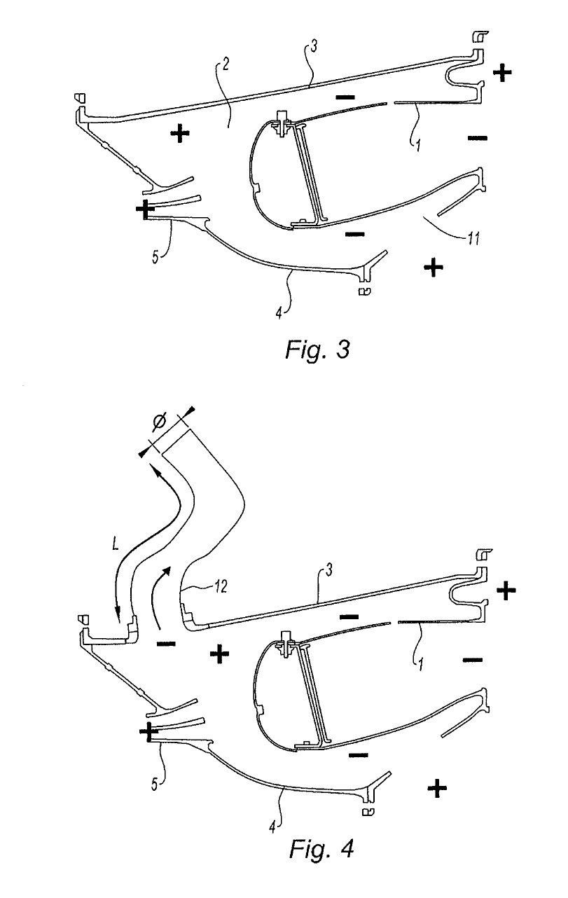

FIG. 3 is a diagrammatic view in section of a prior art combustion chamber;

FIG. 4 is a diagrammatic view in section of a combustion chamber designed using a method of one embodiment of the invention.

Referring to FIG. 1, there is seen a combustion chamber placed downstream of an axial compressor of a turbomachine. The chamber 1 is positioned at the center of a cavity 2 delimited by an exterior casing 3 and an interior chamber casing 4. The chamber is fed with compressed air by the compressor or compressors via a diffuser 5 positioned substantially on the axis of the chamber 1 in the situation represented here of an axial compressor. The chamber 1 also includes, in the conventional way, injectors 6 that feed fuel into the chamber and injection systems 7 that atomize it to facilitate its evaporation and mixing with the air.

FIG. 1 also shows the routing of air in and around the combustion chamber. A first portion enters the injection system 7, around the injector 6, to generate the air-fuel mixture that burns in the chamber 1; a second portion flows around the walls of the chamber, through which it passes by means of ventilation holes, so as to cool said walls; finally, a third portion leaves the cavity 2 via bleed air intakes 10, 11 or 12 and is used to feed and/or to pressurize elements of the aircraft or the engine exterior to the chamber. They are, for example, an intake 10 for the ancillary equipments of the aircraft, an intake 11 for feeding the device for cooling hot parts, such as the blades of the diffuser or the mobile blades of the turbine, or an intake 12 for the flow controlling the clearances at the ends of the turbine blades.

FIG. 2 shows the distribution of the pressure differences relative to the nominal pressure in and around the combustion chamber in the case of a combustion chamber placed downstream of a centrifugal compressor of a turbomachine. This distribution is the result of an acoustic calculation that gives the amplitude of the pressure differences arising at any point in the chamber as a result of instability generated at the level of the flame, for example. In the situation represented, the portion internal to the chamber, which is shown dark and identified by the symbol +, corresponds to an area of high pressure differences, i.e. a pressure antinode, while the parts at the ends of the cavity 2 are shown light and identified by the symbol − and correspond to low pressure differences, i.e. to pressure nodes. Two pressure antinodes are also visible in an intermediate longitudinal position in the cavity 2.

FIG. 3 shows diagrammatically the distribution of the pressure nodes and antinodes in a combustion chamber 1 at the design stage after calculation of the acoustic response to the instabilities generated by combustion.

FIG. 4 shows the distribution of the nodes and antinodes of the same chamber after the same acoustic calculation when a bleed air intake 12 has been added. The intake consists of a pipe of diameter Φ and length L. In accordance with the invention, this intake 12 is positioned at a place where there would have been a pressure antinode before its installation. It is found that after this installation there is now a pressure node, the pressure antinode having been shifted longitudinally in the cavity 2.

Described next is a method of the invention for positioning a bleed air intake on the cavity 2 around the combustion chamber 1 so as to isolate unwanted acoustic phenomena.

Using the calculation code available to them, the combustion chamber designer first analyzes the acoustic modes linked to the shape of the chamber 1 and the cavity 2 that surrounds it. This calculation code takes into account all the elements that it is able to control (injector system 7, diffuser 5 and HP turbine nozzle). This results in a diagram showing the pressure nodes and antinodes associated with the geometry of the chamber in the absence of any bleed air intake. The acoustic modes are defined inter alia by their natural excitation frequency. The designer then identifies the modes that oscillate at a frequency corresponding to a typical combustion frequency and that therefore represent a risk of resonance in the cavity because of excitation supported by combustion.

It is then necessary to process each of these modes to modify their frequency to shift it away from the vibratory frequencies associated with combustion. For each mode to be processed, the chamber designer chooses from among the pressure antinodes those that are situated at the structural locations best placed for installing a bleed air intake pipe and then positions at each of these locations a bleed air intake pipe that is defined for the remainder of the calculation by the following characteristics: a length L and a section Φ.

The designer then resumes the calculation of the acoustic modes by having the chamber equipped with this pipe assume the role of a Helmholtz resonator, the cavity of the Helmholtz resonator consisting of the chamber and its bypass. He then varies the parameters Φ and L until a resonant frequency is found that no longer corresponds to one of the combustion excitation frequencies. In the case of the mode represented in FIG. 4, the resonant frequency, which was 450 Hz before the introduction of a bleed air intake pipe, is raised to 750 Hz, which no longer corresponds to a mode liable to be excited by combustion.

Simply optimizing the positioning of the bleed air intakes in this way and no longer modifying the geometrical characteristics of the chamber 1 and the cavity 2, a chamber is obtained that is no longer subjected to hazardous acoustic phenomena. The question of the acoustic dimensions of the chamber is thus solved in a simple fashion that is easy to implement provided that the designer has available a calculation code for evaluating the acoustic modes of a combustion chamber and the cavity that surrounds it.

Moreover, this method may be applied to an existing chamber to reduce phenomena not controlled or imperfectly controlled at the design stage. Shifting a bleed air intake or modifying its geometrical characteristics are relatively accessible modifications making it possible to solve service life problems that could arise in use. Modifying the geometry of the chamber over the whole of a fleet of turbomachines in service would be much more costly, both technically and financially.

Although the invention has been described with reference to one particular embodiment, it is evident that it encompasses all technical equivalents of the means described and combinations thereof should these fall within the scope of the invention.

1. Method of reducing acoustic vibratory phenomena in the environment of a combustion chamber of a turbomachine, said chamber being positioned in a cavity delimited by an exterior casing and an interior chamber casing, characterized in that it includes at least the following steps:
producing an analysis of at least one vibratory mode of the chamber and the cavity and identifying its resonant frequency and the pressure nodes and antinodes associated with that frequency,
choosing for the vibratory mode to be processed a pressure antinode existing at the level of one of the walls delimiting the cavity,
installing at the level of said antinode a bleed air intake pipe characterized by its diameter and its length,
resuming the analysis of the vibratory mode after introducing said pipe and identifying the new resonant frequency,
determining the length and diameter parameters for said pipe by iteration until the required frequency shift for the vibratory mode concerned is obtained.

2. Method according to claim 1 wherein the pipe is treated like a Helmholtz resonator during the vibratory analysis.

3. Turbomachine module including a combustion chamber and a cavity that surrounds it, one wall of which carries a bleed air intake pipe for pressurizing or supplying with air elements of the aircraft or the engine positioned with the assistance of the method according to claim 1.

4. Turbomachine including a module according to the preceding claim.
